(19) United States
(12) Patent Application Publication
(10) Pub. No.: US 2018/0009341 A1
(43) Pub. Date: Jan. 11, 2018

(54) CAR SEAT STROLLER SYSTEM AND METHOD

(71) Applicant: Jennifer Carlile, Stockton, CA (US)

(72) Inventor: Jennifer Carlile, Stockton, CA (US)

(21) Appl. No.: 15/359,608

(22) Filed: Nov. 22, 2016

Related U.S. Application Data
(60) Provisional application No. 62/358,545, filed on Jul. 5, 2016.

(51) Int. Cl. B60N 2/28; B62B 7/06; B62B 9/20; B62B 7/12; B62B 9/10; B62B 9/24

(52) U.S. Cl. CPC B60N 2/2848; B62B 9/108; B62B 9/24; B62B 9/20; B60N 2/2845; B62B 7/12; B62B 7/06; B60N 2/2881; B62B 2205/14

(57) ABSTRACT

A device for securing and transporting a child is disclosed herein. The device for securing and transporting a child includes a child safety seat, a retractable handle, and a plurality of wheels. The device for securing and transporting a child is useful for securing a child in a vehicle and, alternately rollingly translating the child safety seat over a ground surface when towed via the retractable handle.

### CROSS-REFERENCE TO RELATED APPLICATION

The present application is related to and claims priority to U.S. Provisional Patent Application No. 62/358,545 filed Jul. 5, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of transporting a child and more specifically relates to a child's seat for a land vehicle.

### 2. DESCRIPTION OF RELATED ART

Car seats and strollers are essential items for parents and caregivers of small children. Generally, child safety seats are seats designed specifically to protect children from injury or death during collisions. Many regions require children defined by age, weight, and/or height to use a government-approved child safety seat when riding in a vehicle. Some car manufacturers integrate child safety seats directly into their vehicle's design. However, it is more common for consumers to purchase and install separate seats.

Child safety seats provide passive restraints and must be properly used to be effective. A child must be placed in a car seat when being driven in an automobile and then, after reaching the destination, the child must be removed from the car seat and placed in a stroller before proceeding. Often times, small children nap while in the car seat and are disturbed and woken up when transferred to the stroller. A suitable solution is desired.

U.S. Pat. No. 4,762,331 to Tucker, et al., relates to a combination automobile seat and stroller. The described combination automobile seat and stroller includes a combination car seat and stroller having a plurality of wheels which are pivotable between a first, lowered position for use as a stroller and a second, raised position for use as a car seat. An extendable handle is provided for pushing the apparatus when the wheels are in the first, lowered position. A spring or clip is provided for locking the wheels in the first, lowered position for use as a stroller. The wheels are pivoted to a second, raised position to allow the apparatus to be placed on the seat of an automobile, an airplane seat, or other surface. Slots in the arms of the chair are provided for releasably engaging the apparatus with the seatbelt of the automobile or airplane seat. The apparatus is provided with a selectably extendable footrest which can be retracted when the wheels are pivoted to the second, raised position.

### BRIEF SUMMARY OF THE INVENTION

In view of disadvantages inherent in the known child's seat for a land vehicle art, the present disclosure provides a novel car seat stroller. The general purpose of the present disclosure, which will be described secondly in greater detail, is to provide a car seat stroller.

A device for securing and transporting a child is disclosed herein. The device for securing and transporting a child includes a child safety seat, a retractable handle, and a plurality of wheels and is configured to hold and secure a child to the child safety seat. The child safety seat includes a support frame, an internal harness, and a padded seat affixed to the support frame. A retractable handle is fixed to the support frame and is configured to transfer loads between the retractable handle and the child safety seat. The retractable handle further has a deployed-handle state and stowed-handle state. A plurality of wheels is fixed to the child safety seat and is configured to rollingly translate the child safety seat when towed via the retractable handle. At least two of the plurality of wheels are further configured to retract relative to the child safety seat and the at least two of the plurality of wheels have a deployed-wheel state and a stowed-wheel state.

According to another embodiment, a method of use for the device for securing and transporting a child is also disclosed herein. The method of use for the device for securing and transporting a child includes installing the device for securing and transporting a child in a vehicle, positioning the child in the child safety seat, restraining the child in the child safety seat with the internal harness, removing the device for securing and transporting a child in a vehicle from the vehicle and placing it on the ground when desired, pressing a pushbutton to lower at least two of the plurality of wheels to a deployed-wheel state, deploying the retractable handle from the stowed-handle state, and rollingly-translating the child safety seat to a destination. The method of use further comprises the steps of: removing the child from the internal harness, pressing the pushbutton to raise the at least two of a plurality of wheels to a stowed-wheel state, and placing the retractable handle in a stowed-handle state.

For purposes of summarizing the disclosure, certain aspects, advantages, and novel features of the disclosure have been described herein. It is to be understood that not necessarily all such advantages may be achieved in accordance with any one particular embodiment of the disclosure. Thus, the disclosure may be embodied or carried out in a manner that achieves or optimizes one advantage or group of advantages as taught herein without necessarily achieving other advantages as may be taught or suggested herein. The features of the disclosure which are believed to be novel are particularly pointed out and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures which accompany the written portion of this specification illustrate embodiments and methods of use for the present disclosure, a car seat stroller, constructed and operative according to the teachings of the present disclosure.

FIG. 1 is a side view of the device for securing and transporting a child during an ‘in-use’ condition, according to an embodiment of the disclosure.

FIG. 2 is a side view of the device for securing and transporting a child during an ‘in-use’ condition of FIG. 1, according to an embodiment of the present disclosure.

FIG. 3A, FIG. 3B, and FIG. 3C are detail views of the device for securing and transporting a child of FIG. 1, according to an embodiment of the present disclosure.

FIG. 4A and FIG. 4B are perspective views of the device for securing and transporting a child of FIG. 1, according to an embodiment of the present disclosure.

FIG. 5 is a flow diagram illustrating a method of use for the device for securing and transporting a child, according to an embodiment of the present disclosure.

The various embodiments of the present disclosure will hereinafter be described in conjunction with the appended drawings, wherein like designations denote like elements.

### DETAILED DESCRIPTION

As discussed above, embodiments of the present disclosure relate to a child's seat for a land vehicle and more particularly to a car seat stroller as used to improve the device for securing and transporting a child.

Generally speaking, the present disclosure is directed toward a combination car seat and stroller, capable of transporting children with ease and convenience. It allows for the seamless, uninterrupted transition from a car seat into a stroller while ensuring a child can sit comfortably. The device features a retractable handle and a push button designed to expand wheels from the bottom portion of the seat/stroller. There can be wheels in each of the four corners of the seat's rectangular base having recesses for the wheels. The push button can be in communication with the four wheels such that, when pressed, the push button allows the wheels to extend in order to convert the seat into a stroller. The car seat stroller can be constructed using plastic, metal, padding for the seat, and other suitable materials. The device may be available in different sizes to accommodate children of different ages and/or body types.

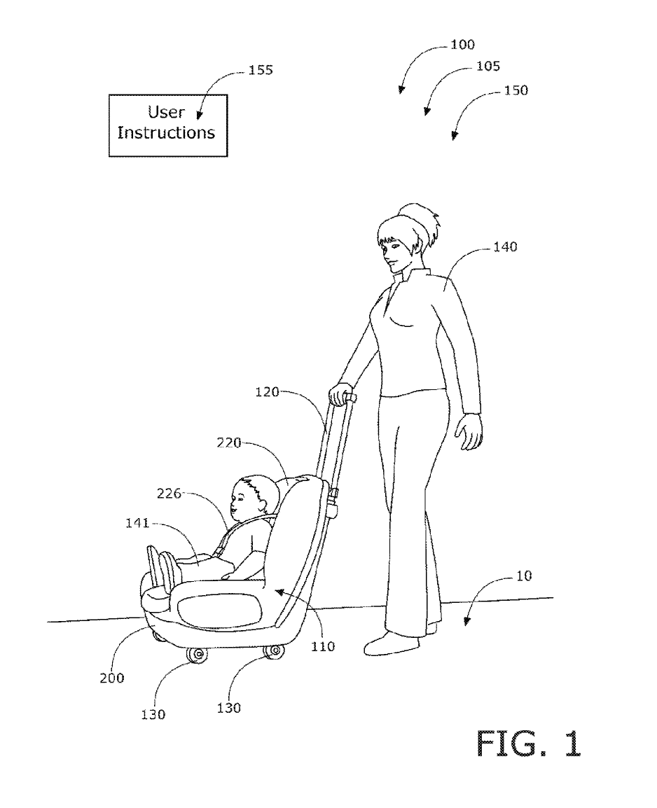

Referring now more specifically to the drawings by numerals of reference, there is shown in FIGS. 1-4, various views of a device for securing and transporting a child 100. FIG. 1 shows a device for securing and transporting a child during an ‘in-use’ condition 150, according to an embodiment of the present disclosure. As illustrated, the device for securing and transporting a child 100 may include child safety seat 110, retractable handle 120, and plurality of wheels 130. The plurality of wheels 130 may be fixed to the child safety seat 110 and configured for a user 140 to rollingly translate child safety seat 110 over a ground surface 10 when pushed or towed via retractable handle 120. The device for securing and transporting a child 100 may be configured to hold and secure child 141 to child safety seat 110.

The child safety seat 110 may further include a support frame 200, an internal harness 226, and a padded seat 220. The padded seat 220 may be removably affixed to support frame 200. The retractable handle 120 may be fixed to support frame 200 and may be configured to transfer loads between retractable handle 120 and child safety seat 110.

According to one embodiment, the device for securing and transporting a child 100 may be arranged as a kit 105. In particular, the device for securing and transporting a child 100 may further include a set of instructions 155. The instructions 155 may detail functional relationships in relation to the structure of the device for securing and transporting a child 100 (such that the device for securing and transporting a child 100 can be used, maintained, or the like, in a preferred manner).

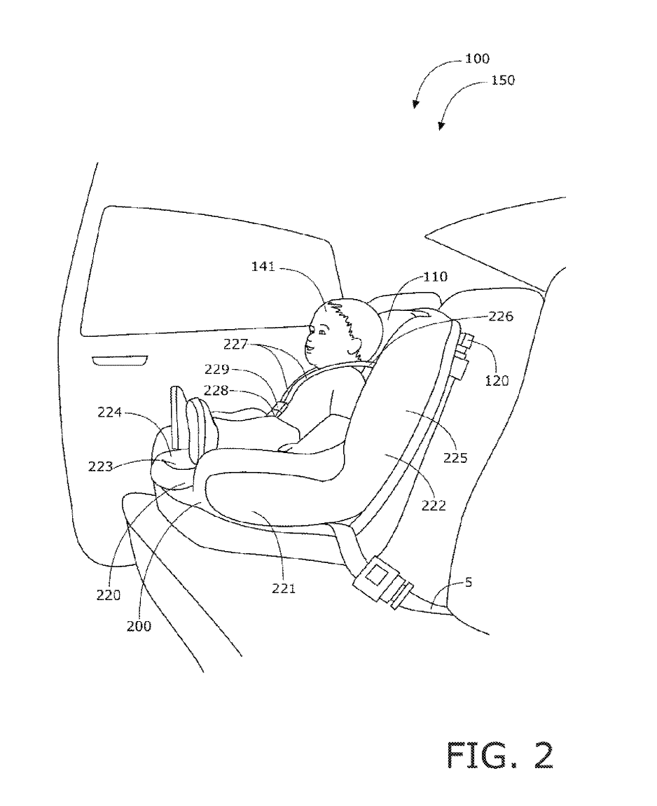

FIG. 2 shows the device for securing and transporting a child of FIG. 1, during an ‘in-use’ condition 150, according to an embodiment of the present disclosure. As above, the device for securing and transporting a child 100 may include the child safety seat 110 and the retractable handle 120. The child safety seat 110 may be configured to hold and secure a child 141 to child safety seat 110. Child safety seat 110 may be removably-integrated with a standard safety restraint system for a vehicle 5 by inserting a vehicle seat belt through openings in the child safety seat 110 and buckling the seat belt as per usual.

As above, the child safety seat 110 may include the support frame 200. Also, the support frame 200 may have the internal harness 226 and the padded seat 220 affixed to it. The internal harness 226 may include a plurality of shoulder straps 227, a crotch strap 228, and a safety-buckle 229, with which a child may be safely secured in the child safety seat 110. The padded seat 220 may include a seat-bottom 221 and a seat-back 222. Seat-bottom 221 and seat-back 222 are configured to anchor the internal harness 226. Seat-bottom 221 and seat-back 222 may be at least partially made of body-supporting materials 223 that include padding 224 that may be configured to cushion child 141. In addition, padding 224 may be further configured to approximate body position of child 141 who may be restrained in child safety seat 110. A durable cover cloth 225 that may have UV-resistant properties may enclose padding 224. Further, durable cover cloth 225 further may be able to be repeatedly cleaned.

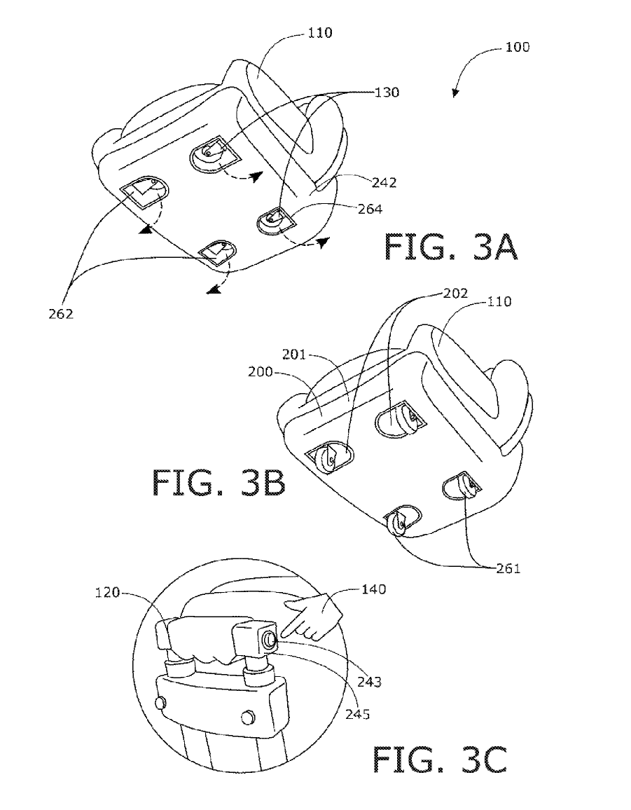

FIG. 3A is a detail view of the device for securing and transporting a child of FIG. 1 with wheels stowed, and FIG. 3B is a detail view with the wheels deployed, according to an embodiment of the present disclosure. To enable movement over ground, the child safety seat 110 may include plurality of wheels 130 fixed to child safety seat 110. However, when secured to a seat of the vehicle, some or all of the plurality of wheels 130 may retract. In particular, the plurality of wheels 130 may further be configured to retract relative to child safety seat 110 and may be able to be configured in a deployed-wheel state 261 and a stowed-wheel state 262. For example, at least two of the plurality of wheels 130 may be retractable into an individual cavity 202, respectively, in their stowed-wheel state 262.

As illustrated, some or all of the plurality of wheels 130 may be retractable into the child safety seat 110. In particular, the support frame 200 may further include a base-member 201. The base-member 201 of support frame 200 may include one or more cavities 202 configured to house one or more wheels 130. For example, the plurality of wheels 130 may be configured in the deployed-wheel state 261 and the stowed-wheel state 262 to stow into and deploy from the base-member 201. According to one embodiment, at least two of plurality of wheels 130 in stowed-wheel state 262 may be configured to lock out, such that at least two of plurality of wheels 130 are able to be rolled over a ground surface 10 (FIG. 1), while another two wheels may be fixed in a deployed (rolling) configuration.

According to one embodiment, the plurality of wheels 130 may rotate between their respective deployed-wheel state 261 and stowed-wheel state 262 about a rotational axis of deployment, respectively. As shown, each of the plurality of wheels 130 may rotate 90 degrees (or at least 85 degrees) about their respective rotational axis of deployment between the deployed-wheel state 261 and the stowed-wheel state 262, into and out of the child safety seat 110.

According to one embodiment, the plurality of wheels 130 may be coupled to a rotator-link 264. The rotator-link 264 may link together at least two of plurality of wheels 130 to rotate in synchronized motion. In particular, when moving between the deployed-wheel state 261 and the stowed-wheel state 262, at least two of plurality of wheels 130 may rotate about their respective rotational axis of deployment at the same time.

According to one embodiment, each rotator-link 264 may be functionally coupled with a master-link 242, such that movement of each rotator-link 264 may be simultaneously initiated by activation of master-link 242. For example, from the deployed-wheel state 261, activation of the master-link 242 may engage at least two rotator-links 264, which may each at least partially retract at least two wheels 130 into their respective cavities 202, placing the plurality of wheels 130 in the stowed-wheel state 262.

FIG. 3C is a detail view of the device for securing and transporting a child of FIG. 1, according to an embodiment of the present disclosure. The retractable handle 120 may include a quick release (such as pushbutton 243) proximate to first-grip-end 245. User 140 may be able to depress pushbutton 243. Here, the pushbutton 243 may be mechanically coupled to the master-link 242, discussed above, such that upon first activation of pushbutton 243, the master-link 242 initiates rotation of at least two of plurality of wheels 130 (FIG. 3B) toward deployed-wheel state 261 (FIG. 3B) and completes rotation at lock out stop. A second activation of pushbutton 243 may release the lock out stop and initiate the master-link 242 rotation of at least two of plurality of wheels 130 (FIG. 3A) toward stowed-wheel state 262 (FIG. 3A).

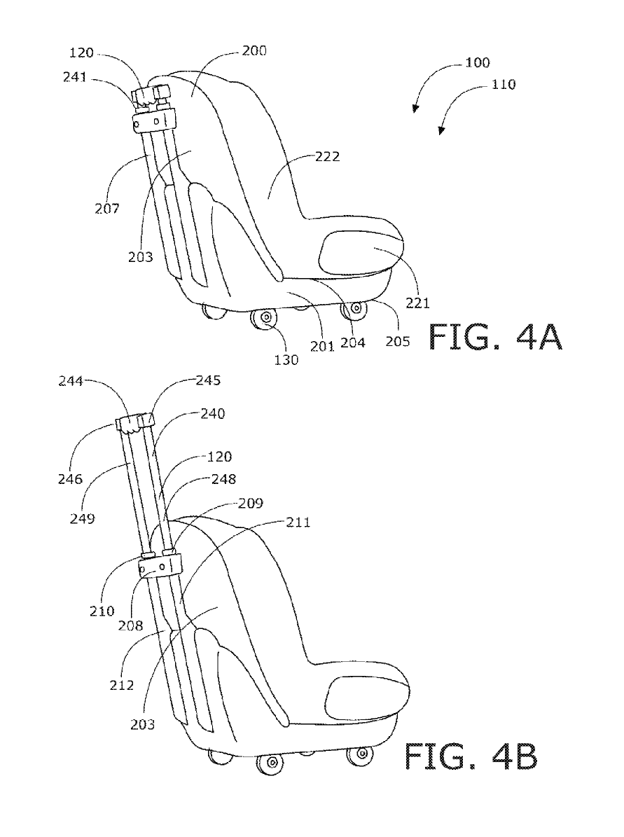

FIG. 4A is a perspective view of the device for securing and transporting a child of FIG. 1 with its handle stowed, and FIG. 4B is a detail view with its handle deployed, according to an embodiment of the present disclosure. In particular, the retractable handle 120 may have deployed-handle state 240 and stowed-handle state 241. Further, the retractable handle 120 may be fixed to the support frame 200 and configured to transfer loads between retractable handle 120 and child safety seat 110.

The support frame 200 may include the base-member 201 and a back-member 203. The base-member 201 may have upper surface 204 and lower surface 205. The upper surface 204 may be configured to receive and the support seat-bottom 221, while the lower surface 205 may be configured to receive and support at least one of a plurality of wheels 130. The back-member 203 may be configured to support the seat-back 222, while fixing or retaining the seat-bottom 221 and the seat-back 222 in an upright position, such as at an angle between 85 degrees and 120 degrees relative to each other. In addition, support frame 200 may be at least partially made of durable plastic materials that are able to resist damage when the child safety seat 110 is traversed over rough, and alternatively wet, surfaces, in addition to any applicable safety standards.

Loads transferred between retractable handle 120 and child safety seat 110 may be transferred via the back-member 203. In addition, the back-member 203 may be configured to stow away at least portions of the retractable handle 120 when retractable handle 120 is in the stowed-handle state 241. The back-member 203 may further include a handle receiver 207 configured to slidably-retain retractable handle 120 when the retractable handle 120 is in stowed-handle state 241. The handle receiver 207 may include a first-extension-arm-receiver 211 and a second-extension-arm-receiver 212.

According to one embodiment, the retractable handle 120 may include a hand grip 244, a first-extension-arm 248, and a second-extension-arm 249. The hand grip 244 may be configured for the user 140 (FIG. 1) to hold, push, pull, tilt, and maneuver the child safety seat 110. The hand grip 244 may be at least partially made from non-slip elastomeric materials and may be configured to retain gripping properties when exposed to wet, and alternatively humid environments.

Further, the hand grip 244 may have a first-grip-end 245 and a second-grip-end 246 laterally opposite the first-grip-end 245. The first-extension-arm 248 may be coupled to the first-grip-end 245, and the second-extension-arm 249 may be coupled to the second-grip-end 246. For example, together the hand grip 244, the first-extension-arm 248, and the second-extension-arm 249 may generally form a U-shape. As shown, when configured in the U-shape, first-extension-arm 248 and second-extension-arm 249 may be substantially parallel with each other. The first-extension-arm 248 and the second-extension-arm 249 may be further configured to extend from and retract through a guide 208 proximate to back-member 203. Guide 208 may include a first-extension-arm bushing 209 and a second-extension-arm bushing 210. In addition, the first-extension-arm 248 may be telescopically coupled with a first-extension-arm-receiver 211 of back-member 203, and the second-extension-arm 249 may be telescopically coupled with the second-extension-arm-receiver 212 of back-member 203.

Advantageously, the present disclosure may save an extensive amount of time, effort, and frustration when transporting a child in a vehicle or in a stroller while at the park, zoo, store, and other locations. It eliminates the need to transport multiple car seats, strollers, and other equipment, offering a way to save space within a vehicle. The car seat can be placed in the rear portion of a vehicle and utilized as a standard car seat when a seatbelt is applied. A child can sit comfortably in the seat as his/her parent or guardian operates the vehicle. Once parked, the parent/guardian can retrieve the seat from the vehicle. The handle can be extended and the push button can be activated to expand the wheels from the base. The seat can be placed on the ground and pushed as a stroller via the handle. The device offers a way to transition a child from their car seat to a stroller without disturbing him/her.

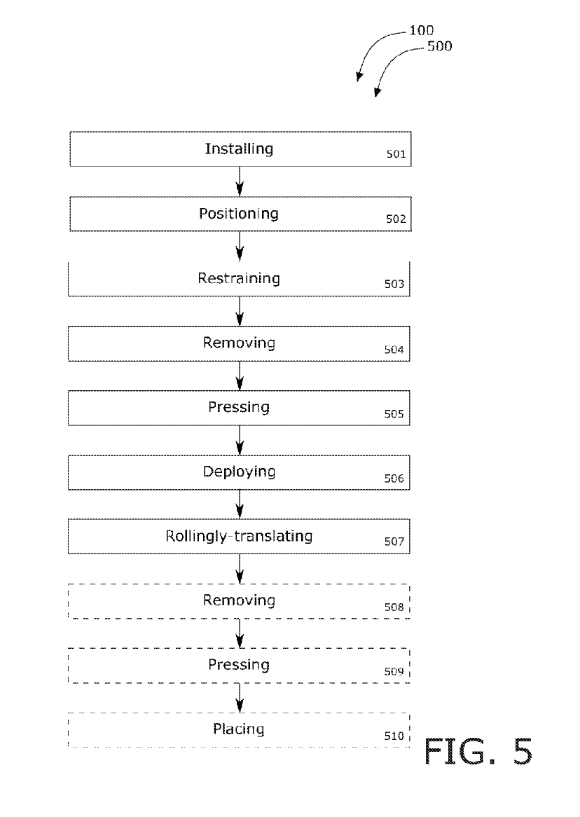

FIG. 5 is a flow diagram illustrating a method for use of a device for securing and transporting a child, according to an embodiment of the present disclosure. In particular, the method for use of a device for securing and transporting a child 500 may include one or more components or features of the device for securing and transporting a child 100 as described above. As illustrated, the method for use of a device for securing and transporting a child 500 may include the steps of: step one 501, installing a device for securing and transporting a child in a vehicle; step two 502, positioning the child in a child safety seat; step three 503, restraining the child in the child safety seat with an internal harness; step four 504, removing the device for securing and transporting a child in a vehicle from the vehicle and placing on the ground when desired; step five 505, pressing a pushbutton to at least two of a plurality of wheels to a deployed-wheel state; step six 506, deploying a retractable handle from the stowed-handle state; and step seven 507, rollingly-translating the child safety seat to a destination. In addition, the method 500 may include a step eight 508, removing the child from the internal harness; a step nine 509, pressing the pushbutton to place the at least two of a plurality of wheels in a stowed-wheel state; and a step ten 510, placing the retractable handle in a stowed-handle state.

It should be noted that steps 508, 509, and 510 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for use of device for securing and transporting a child (e.g., different step orders within above-mentioned list, elimination or addition of certain steps, including or excluding certain maintenance steps, etc.), are taught herein.

The embodiments of the disclosure described herein are exemplary and numerous modifications, variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for securing and transporting a child, the device comprising:
a child safety seat including a support frame and an internal harness, the child safety seat further including a padded seat affixed to the support frame, the child safety seat configured to hold and secure a child to the child safety seat;
a retractable handle fixed to the support frame and configured to transfer loads between the retractable handle and the child safety seat, the retractable handle having a deployed-handle state and a stowed-handle state; and
a plurality of wheels fixed to the child safety seat configured to rollingly translate the child safety seat when towed or pushed via the retractable handle, at least two of the plurality of wheels further configured to retract relative to the child safety seat, the at least two of the plurality of wheels having a deployed-wheel state and a stowed-wheel state.

2. The device of claim 1, wherein the padded seat includes a seat-bottom and a seat-back; and
wherein the support frame includes a base-member configured to support the seat-bottom, and a back-member configured to support the seat-back, the support frame further configured to retain the seat-bottom and the seat-back at an angle between 85 degrees and 120 degrees relative to each other.

3. The device of claim 2, wherein the base-member has an upper surface and a lower surface, the upper surface configured to receive and support the seat-bottom, the lower surface configured to receive and support the plurality of wheels;
wherein the base-member includes at least one cavity configured to house the at least two of the plurality of wheels having the deployed-wheel state and the stowed-wheel state; and
wherein the at least two of the plurality of wheels having the deployed-wheel state and the stowed-wheel state are further configured to lock out, such that the at least two of the plurality of wheels are able to be rolled on a ground surface when in said deployed-wheel state, and to at least partially retract into the at least one cavity when in said stowed-wheel state.

4. The device of claim 3, wherein each of the at least two of the plurality of wheels having the deployed-wheel state and the stowed-wheel state have a rotational axis of deployment, and each rotational axis of deployment rotates at least 85 degrees between said deployed-wheel state and said stowed-wheel state.

5. The device of claim 3 wherein the at least two of the plurality of wheels having the rotational axis of deployment between the deployed-wheel state and the stowed-wheel state are coupled to a rotator-link such that the at least two of the plurality of wheels are able to rotate in parallel motion with each other when in motion between the deployed-wheel state and the stowed-wheel state.

6. The device of claim 5 wherein each rotator-link of each at least two of the plurality of wheels is fixedly-joined with a master-link such that movement of each rotator-link is simultaneously initiated by activation of the master-link.

7. The device of claim 2, wherein loads transferred between the retractable handle and the child safety seat are transferred via the back-member; and
wherein the back-member is configured to stow at least portions of the retractable handle when the retractable handle is in the stowed-handle state.

8. The device of claim 7 wherein the back-member includes a handle receiver configured to slidably-retain the retractable handle.

9. The device of claim 8, wherein the retractable handle includes a hand grip, a first-extension-arm, and a second-extension-arm, the hand grip having a first-grip-end and a second-grip-end laterally opposite the first-grip-end, the first-extension-arm coupled to first-grip-end and the second-extension-arm coupled to second-grip-end together in a U-shape with the first-extension-arm, and the second-extension-arm substantially parallel with each other; and
wherein the hand grip is configured for a user to hold to push, pull, tilt, and maneuver the child safety seat.

10. The device of claim 9, wherein the retractable handle further includes a quick release proximate to the first grip end, the quick release configured to deploy the at least two of the plurality of wheels towards the deployed-wheel state and completing a deployment at the lock out stop upon a first activation of said quick release, the quick release further configured to release said lock out stop and to stow the at least two of the plurality of wheels towards the stowed-wheel state upon a second activation of said quick release.

11. The device of claim 9, wherein the hand grip is at least partially made from non-slip elastomeric materials, and is configured to retain gripping properties when exposed to wet, and alternatively humid environments.

12. The device of claim 9, wherein the first-extension-arm and the second-extension-arm are configured to extend from and retract through a guide proximate to the back-member, the guide including a first-extension-arm bushing and a second-extension-arm bushing; and
wherein the first-extension-arm is coupled with a first-extension-arm-receiver and the second-extension-arm is coupled with a second-extension-arm-receiver such that the retractable handle is able to be raised from a deployed-handle state and alternatively lowered to a stowed-handle state.

13. The device of claim 1, wherein the support frame is at least partially made of durable plastic materials that are able to resist damage when the child safety seat is traversed over rough, and alternatively wet, surfaces.

14. The device of claim 1, wherein the child safety seat is able to be removably-integrated with a standard safety restraint system for a vehicle.

15. The device of claim 2, wherein the seat-bottom and seat-back are at least partially made of body-supporting materials including
padding configured to cushion a child from the support frame, said padding further configured to approximate a body position of said child when restrained in said child safety seat; and
a durable cover cloth having UV-resistant properties, said durable cover cloth able to be repeatedly cleaned.

16. The device of claim 2, wherein the internal harness includes a plurality of shoulder straps, a crotch strap, and a safety-buckle, the internal harness configured to couple with the seat-bottom and seat-back.

17. A device for securing and transporting a child, the device comprising:
a child safety seat including a support frame and an internal harness, the child safety seat further including a padded seat affixed to said support frame, said child safety seat configured to hold and secure a child to said child safety seat;
a retractable handle fixed to said support frame and configured to transfer loads between said retractable handle and said child safety seat, said retractable handle having a deployed-handle state and a stowed-handle state;
a plurality of wheels fixed to said child safety seat configured to rollingly translate said child safety seat when towed or pushed via said retractable handle, and at least two of the plurality of wheels further configured to retract relative to said child safety seat, said at least two of the plurality of wheels having a deployed-wheel state and a stowed-wheel state;
wherein said padded seat includes a seat-bottom and a seat-back;
wherein said support frame includes a base-member configured to support said seat-bottom, and a back-member configured to support said seat-back, said support frame further configured to retain said seat-bottom and said seat-back at an angle between 85 degrees and 120 degrees relative to each other;
wherein said base-member has an upper surface and a lower surface, said upper surface configured to receive and support said seat-bottom, said lower surface configured to receive and support said the plurality of wheels;
wherein said base-member includes at least one cavity configured to house said at least two of the plurality of wheels having said deployed-wheel state and said stowed-wheel state;
wherein said at least two of the plurality of wheels having said deployed-wheel state and said stowed-wheel state are further configured to lock out, such that said at least two of the plurality of wheels are able to be rolled on a ground surface when in said deployed-wheel state, and to at least partially retract into said at least one cavity when in said stowed-wheel state;
wherein said each of the at least two of the plurality of wheels having said deployed-wheel state and said stowed-wheel state have a rotational axis of deployment, and each rotational axis of deployment rotates at least 85 degrees between said deployed-wheel state and said stowed-wheel state;
wherein said at least two of the plurality of wheels having said rotational axis of deployment between said deployed-wheel state and said stowed-wheel state are coupled to a rotator-link such that said at least two of the plurality of wheels are able to rotate in parallel motion with each other when in motion between said deployed-wheel state and said stowed-wheel state;
wherein each said rotator-link of each said at least two of the plurality of wheels is fixedly-joined with a master-link such that movement of each said rotator-link is simultaneously initiated by activation of said master-link;
wherein loads transferred between said retractable handle and said child safety seat are transferred via said back-member;
wherein said back-member is configured to stow at least portions of said retractable handle when said retractable handle is in said stowed-handle state;
wherein said back-member includes a handle receiver configured to slidably-retain said retractable handle;
wherein said retractable handle includes a hand grip, a first-extension-arm, and a second-extension-arm, said hand grip having a first-grip-end and a second-grip-end laterally opposite said first-grip-end, said first-extension-arm coupled to said first-grip-end and said second-extension-arm coupled to said second-grip-end together in a U-shape with said first-extension-arm, and said second-extension-arm substantially parallel with each other;
wherein said hand grip is configured for a user to hold to push, pull, tilt, and maneuver said child safety seat;
wherein said retractable handle further includes a quick release proximate to the first grip end, the quick release configured to deploy the at least two of the plurality of wheels towards the deployed-wheel state and completing a deployment at the lock out stop upon a first activation of said quick release, the quick release further configured to release said lock out stop and to stow the at least two of the plurality of wheels towards the stowed-wheel state upon a second activation of said quick release;
wherein said hand grip is at least partially made from non-slip elastomeric materials and is configured to retain gripping properties when exposed to wet, and alternatively humid, environments;
wherein said first-extension-arm and said second-extension-arm are configured to extend from and retract through a guide proximate to said back-member, the guide including a first-extension-arm bushing and a second-extension-arm bushing;
wherein said first-extension-arm is coupled with said first-extension-arm-receiver and said second-extension-arm is coupled with said second-extension-arm-receiver such that said retractable handle is able to be raised from said deployed-handle state and alternatively lowered to said stowed-handle state;
wherein said support frame is at least partially made of durable plastic materials that are able to resist damage when said child safety seat is traversed over rough, and alternatively wet, surfaces;
wherein said child safety seat is able to be removably-integrated with a standard safety restraint system for a vehicle;
wherein said seat-bottom and said seat-back are at least partially made of body-supporting materials including padding configured to cushion said child from the support frame, said padding further configured to approximate a body position of said child when restrained in said child safety seat, and a durable cover cloth having UV-resistant properties, said durable cover cloth able to be repeatedly cleaned; and
wherein said internal harness includes a plurality of shoulder straps, a crotch strap, and a safety-buckle, the internal harness configured to couple with the seat-bottom and seat-back.

18. The device for securing and transporting a child of claim 17, further comprising set of instructions; and
wherein the device is arranged as a kit.

19. A method of using the device for securing and transporting a child, the method comprising the steps of:
installing a device for securing and transporting a child in a vehicle;
positioning the child in a child safety seat;
restraining the child in the child safety seat with an internal harness;
removing the device for securing and transporting a child in a vehicle from the vehicle and placing on the ground;
pressing a pushbutton configured to deploy at least two of a plurality of wheels to a deployed-wheel state;
deploying a retractable handle from a stowed-handle state; and
rollingly-translating the child safety seat.

20. The method of claim 19, further comprising the steps of:
removing the child from the internal harness;
pressing the pushbutton further configured to stow place the at least two of the plurality of wheels in a stowed-wheel state; and
placing the retractable handle in a stowed-handle state.
